(19) United States
(12) Patent Application Publication
(10) Pub. No.: US 2022/0164010 A1
(43) Pub. Date: May 26, 2022

(54) DOORS HINGEDLY ATTACHED TO ELECTRONIC DEVICE COMPONENT HOUSING

(71) Applicant: Hewlett-Packard Development Company, L.P., Spring, TX (US)

(72) Inventor: David Quijano, Spring, TX (US)

(73) Assignee: Hewlett-Packard Development Company, L.P., Spring, TX (US)

(21) Appl. No.: 17/599,602

(22) PCT Filed: Jul. 24, 2019
(86) PCT No.: PCT/US2019/043311

§ 371 Date: Sep. 29, 2021

(51) Int. Cl. G06F 1/18; F16M 11/04; G06F 1/16

(52) U.S. Cl. CPC G06F 1/181; G06F 1/1607; G06F 1/1681; F16M 11/04

(57) ABSTRACT

A system includes a housing defining an interior to receive components of an electronic device. The system includes a door that is hingedly attached to the housing. A post is coupled to the door. The post has an elongated body with a spherical ball at an end of the post. The system also includes a slot to receive the post. The slot is shaped to correspond to a shape of the elongated body and the spherical ball. A socket is connected to the slot, and the socket is to mate with the spherical ball and to cause rotation of the door about the socket to open or close the interior.

### BACKGROUND

The form factor (size, physical arrangement) of electronic devices such as desktop computing devices is becoming smaller. Such reduction in form factor can save space and reduce clutter around a user's work space. Larger or bulkier computing device components may be separately provided outside of the electronic device.

### BRIEF DESCRIPTION OF THE DRAWINGS

FIG. 1 illustrates an electronic device mounted according to an example configuration of the present disclosure.

FIG. 2 illustrates a front perspective and exploded view of the door separated from the component housing according to an example of the present disclosure.

FIG. 3 illustrates a back perspective and exploded view of the component housing separated from the door according to an example of the present disclosure.

FIG. 4 shows a cross-sectional view of the component housing and the door as viewed through line AA of FIG. 2 according to an example of the present disclosure.

FIG. 5 illustrates the door in position for mating with the component housing according to an example of the present disclosure.

FIG. 6A is a side plan view of the door and the component housing at a first position according to an example of the present disclosure.

FIG. 6B is a side plan view of the door and the component housing at a second position according to an example of the present disclosure.

FIG. 6C is a side plan view of the door and the component housing at a third position according to an example of the present disclosure.

FIG. 6D is a side plan view of the door and the component housing at a fourth position according to an example of the present disclosure.

FIG. 7 illustrates the component housing and the door of FIG. 1 in an example closed state.

FIG. 8 illustrates the locking member of FIG. 7 according to an example of the present disclosure.

FIG. 9 illustrates an electronic device mounted according to an example configuration of the present disclosure.

FIG. 10 illustrates an electronic device mounted according to an example configuration of the present disclosure.

FIG. 11 illustrates the electronic device sleeve of FIG. 1, in which a computing device is disposed according to an example configuration of the present disclosure.

### DETAILED DESCRIPTION

One approach to deterring theft of electronic devices such as computing devices is to employ an electronic device sleeve to physically secure the computing device onto a user's workspace. After the electronic device sleeve is secured, a component housing to store external components of the electronic device may be secured to the electronic device sleeve. The component housing may have a lid/door to access the housing interior.

A challenge for many users is that the lid merely snaps onto the component housing and is not tethered or otherwise attached to the component housing. Upon removing the lid, it is immediately dislodged onto a user's hand. This separation is highly inconvenient because the user has to keep track of the lid which can be easily misplaced.

An example of the present disclosure facilitates the hinged attachment of a door to its component housing. The door uses a post having a spherical ball to mate with a corresponding socket of the component housing. This arrangement causes rotation of the door about the socket when the door is opened or closed. In this manner, when opened, the door is not dislodged and remains attached to the component housing. This system is highly convenient, and users need not keep track of the door nor can the door be misplaced.

Moreover, at a user's option, the door can be easily detached from the component housing by rotating the door toward a complementary slot for the spherical ball. In this manner, the door can be removed if the need arises.

Another challenge faced by users is that although the component housing can be mounted on the back of an electronic device sleeve, tools are used to engage the screw bosses on the electronic device sleeve.

An example of the present disclosure facilitates toolless mounting of the component housing to the electronic device sleeve by providing a locking member having a threaded post that can be attached to the electronic device sleeve without a tool. A corresponding aperture of the component housing secures the component housing to the electronic device sleeve. In this manner, component housing installation is highly efficient and convenient for many users.

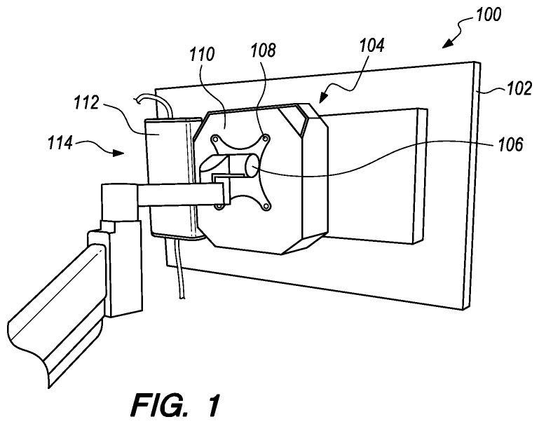

FIG. 1 illustrates an electronic device 100 mounted according to an example configuration of the present disclosure.

In FIG. 1, electronic device 100 can include a monitor 102 and a computing device 104 to process data instructions. Monitor 102 is itself mounted on a monitor arm 106 to conveniently display images to a user. Computing device 104 may be disposed in an electronic device sleeve 110. In turn, electronic device sleeve 100 may be mounted on the back surface of monitor 102 and secured into place with monitor arm 106. Monitor arm 106 may utilize mounting holes 108 on monitor 102 to secure monitor 102.

According to an example configuration of the present disclosure, a component housing 112 is hingedly attached to a door 114 and is conveniently secured to the side of electronic device sleeve 110 of monitor arm 106 as shown in FIG. 1. As previously noted, larger electronic device components may be provided as external components to reduce the form factor of the electronic device. Component housing 112 can thus hold such external electronic device components.

An example of an external component is an external power supply unit (ePSU). Other such components may also be housed in component housing 112. As another example, an external hard drive may be stored in component housing 112. In this manner, component housing 112 containing external components can be securely fastened to electronic device sleeve 110 to form a single integrated unit to save space and to increase user convenience.

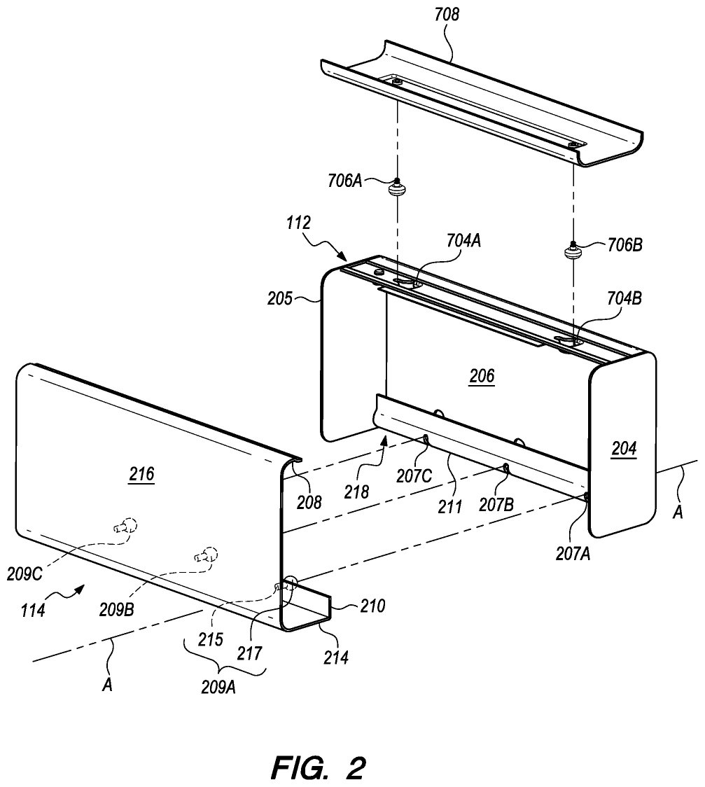

Door 114 may be hingedly coupled to component housing 112 to provide axial rotation of door 114 to open and close component housing 112 as further discussed with reference to FIGS. 2 through 4 below. Door 114 is also easily attachable and detachable from component housing 112 as also discussed with reference to FIGS. 2 through 4 below.

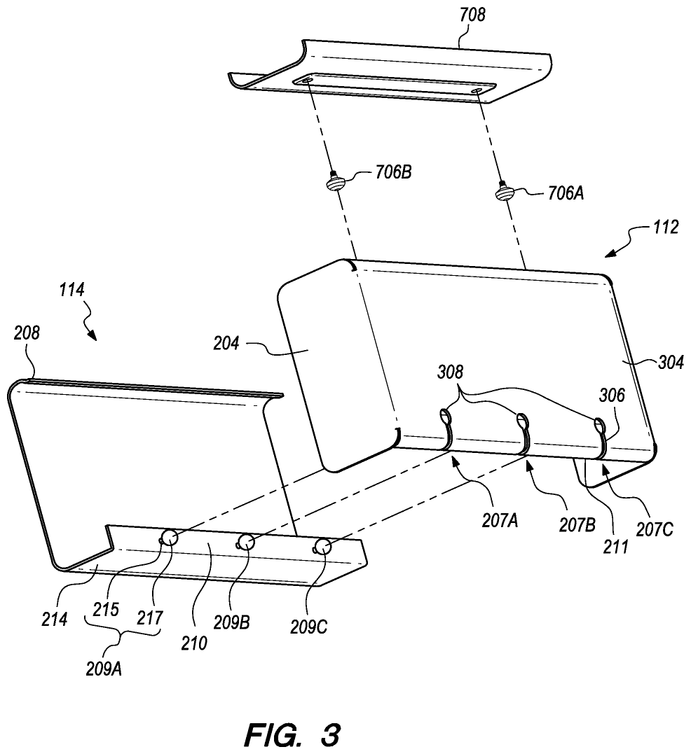

FIGS. 2 to 4 illustrate various views of component housing 112 and door 114. Specifically, FIG. 2 illustrates a front perspective and exploded view of door 114 separated from component housing 112; FIG. 3 illustrates a back perspective and exploded view of component housing 112 separated from door 114;

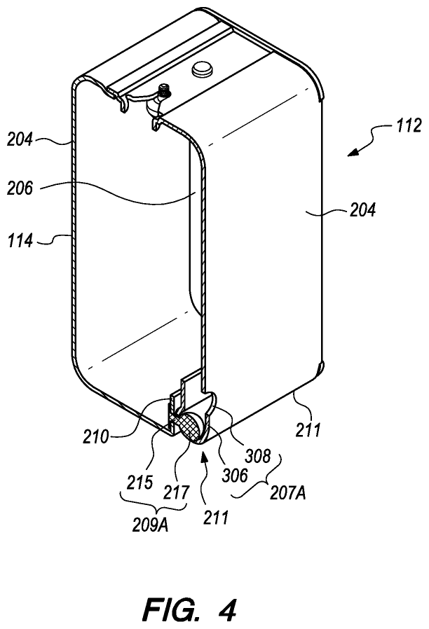

FIG. 4 shows a cross-sectional view of component housing 112 and door 114 as viewed through line AA of FIG. 2.

Referring now to FIGS. 2, 3 and 4, in one example, component housing 112 defines an interior 206 to receive components of electronic device 100. In another example, component housing 112 is an enclosure having an opening to receive components of the electronic device. Such an enclosure (and door) can attach to an electronic device sleeve in which the electronic device is disposed. In a further example, component housing 112 may be a component case to hold components of electronic device 100. Other descriptions of component housing 112 may be applicable. For example, component housing 112 might be a receptacle that defines an interior.

In the figures, door 114 may be hingedly attached or coupled to the component housing to cover interior 206. Alternatively, door 114 may be replaced with a cover or lid to provide access to interior 206. As shown in FIGS. 2 and 3, door 114 includes three panels: a top panel 208, a bottom panel 214 and a front panel 216. Front panel 216 forms the front area of the door that encloses interior 206. Door 114 also includes a back lip 210 to which posts (or post hinges) are attached. The planes of the adjoining panels (and lip 210) are substantially perpendicular to each other.

In one example of the present disclosure, multiple post hinges are coupled to back lip 210 including a first post hinge 209A, a second post hinge 209B and a third post hinge 209C that can mate with a cavity or socket hinge 211 (more clearly shown in FIG. 3). Each one of first, second and third post hinges 209A, 209B, 209C includes an elongated body 215 with a spherical ball 217 at its end. Alternatively, each post hinge 209A, 209B, 209C may be a protrusion or post with an extended support having a circular end or partial circular or spherical end.

In the figures, each one of first, second and the third post hinges 209A, 209B, and 209C is received by a respective complementary first, second and third slot 207A, 207B and 207C. Thus, the first, second and third slots 207A, 207B and 207C are shaped to correspond to the shape of elongated body 215 and spherical ball 217 as shown.

That is, the shapes of the slots and the post hinges are complementary. More specifically, first, second and third slots 207A, 207B and 207C include an elongated section 306 and a spherical section 308 to receive the post hinges (FIG. 3).

In one example, first, second and third slots 207A, 207B and 207C are connected to socket hinge 211. In this manner, when received by a slot, the post hinge is channeled toward socket hinge 211 where mating occurs by snapping spherical ball 217 into socket hinge 211.

In one example, first second and third slots 207A, 207B and 207C extend from a back area 304 (FIG. 3) to a front area 218 (FIG. 2) of socket hinge 211 to permit axial rotation of the door. In another example, spherical section 308 (FIG. 3) of each one of first second and third slots 207A, 207B and 207C is positioned above socket hinge 211 to cause downward movement of post hinges 209A, 209B, 209C to mate with socket hinge 211. By “downward movement,” it is meant that the post hinges are assisted by gravity or by a user's pull to proceed in a direction from spherical section 308, along elongated section 306 to socket hinge 211.

It is noted that the shape of the elongated section 306 encircling socket hinge 211 remains elongated to retain the spherical ball in the first, second and third slots 207A, 207B and 207C within socket hinge 211 during axial rotation.

Referring now to FIGS. 2, 3 and 4, component housing 112 also includes socket hinge 211, as noted above, to mate with spherical ball 217 and to cause rotation of door 114 about socket hinge 211 to open or close interior 206. Spherical ball 217 can be seen mated inside socket hinge 211 of FIG. 4. The shape (cross-section) of socket hinge 211 is spherical to complement the shape of spherical ball 217 as shown in FIG. 4. In another example, the shape may be circular or partially spherical to complement the shape of a corresponding circular or partially spherical. In a further example, socket hinge 211 may mate with a corresponding spherical end to cause hinged rotation of a lid about the socket hinge.

In FIGS. 3 and 4, socket hinge 211 extends from a right-side panel 204 to a left side panel 205 of component housing 112. Here, socket hinge 211 may mate with a spherical end of a post hinge to cause hinged rotation of a lid about socket hinge 211.

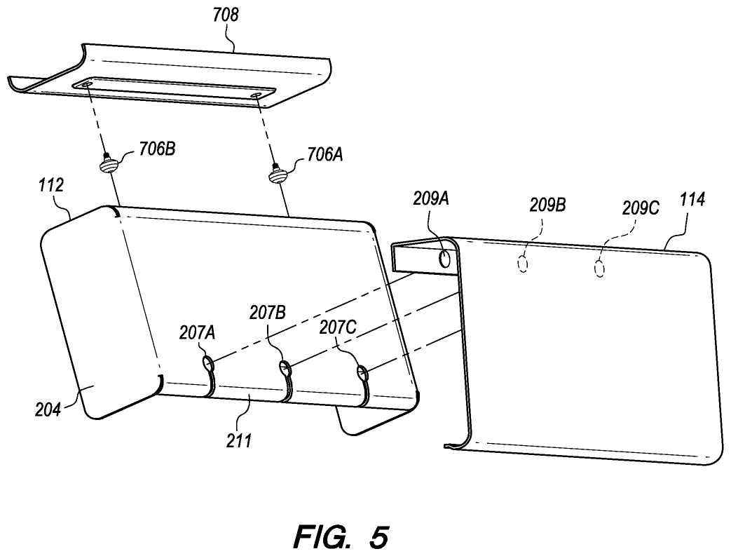

In operation, as illustrated in FIG. 4 and FIG. 5, a user begins by positioning door 114 behind component housing 112 so that first, second and third post hinges 209A, 209B and 209C are respectively aligned with first, second and third slots 207A, 207B and 207C. Once aligned, the spherical ball for each post is inserted into the corresponding slot and guided down the slot into socket hinge 211 where the spherical ball of the post is mated.

In this manner, a system to hingedly couple doors and corresponding component housing is formed. However, the system is not limited to attaching doors and component housing. As another example, the system may also be a joint assembly to hingedly couple covers and component cases. As a further example, the system may also hingedly couple lids and enclosures.

Without the hinge or ball/socket mechanism described above, a door can be easily misplaced when completely separated from the component housing. It is highly inconvenient for users to track the door separately from the component housing.

FIG. 5 illustrates door 114 in position for mating with component housing 112 according to an example of the present disclosure.

In FIG. 5, door 114 of FIG. 3 has been repositioned behind component housing 112 as shown. First post hinge 209A is now aligned with first slot 207A. Second and third post hinges 209B and 209C, shown in broken lines, are also respectively aligned with second and third slots 207B and 207C. The spherical ball for each post hinge can then be inserted and channeled through the corresponding slot for mating with socket hinge 211.

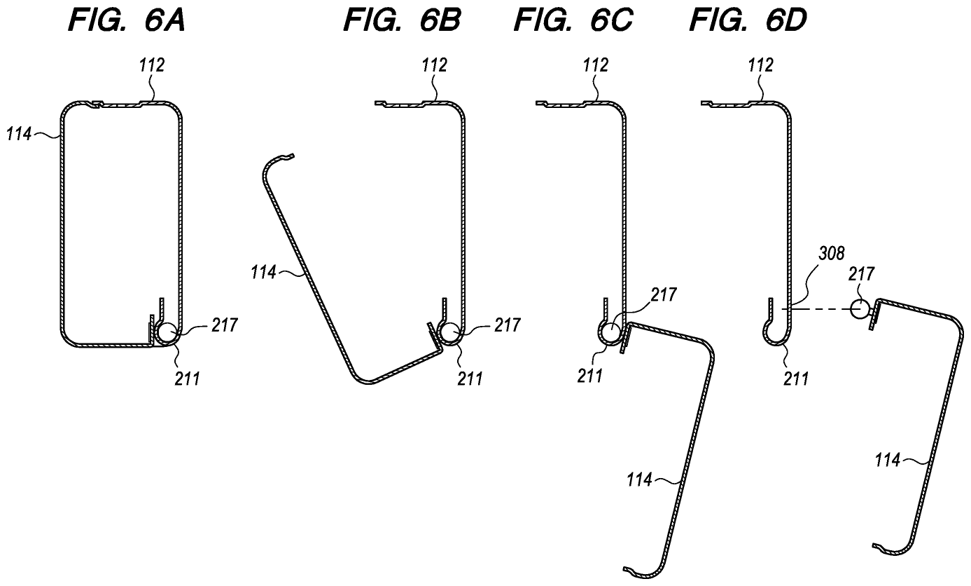

FIGS. 6A-6D are side plan views of door 114 and component housing 112 at various door positions.

In FIG. 6A-6D, positions of door 114 from a closed position through detachment from component housing 112 are shown. Specifically, in FIG. 6A, door 114 is shown in a closed position with component housing 112. At FIG. 6B, door 114 is partially open and remains mated to socket hinge 211. At FIG. 6C, door 114 has been further rotated beyond the position shown in FIG. 6B, but remains mated to socket hinge 211. At FIG. 6D, door 114 has been rotated behind component housing 112 toward spherical section 308 (FIG. 3). As previously noted, spherical section 308 is positioned at the rear of component housing 112. As a result, door 114 is easily detachable (or attachable) from socket hinge 211 as shown.

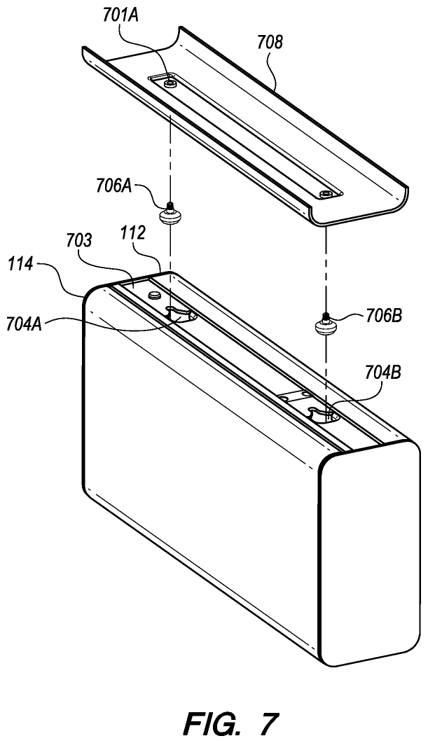

FIG. 7 illustrates component housing 112 and door 114 of FIG. 1 in an example closed state.

As shown in FIG. 7, component housing 112 and door 114 form a substantially rectangular casing with rounded edges to house external electronic device components. Component housing 112 can include an attachment surface 703 having a first mating aperture 704A and a second mating aperture 704B. First and second mating apertures 704A, 704B can respectively mate with first and second locking members 706A, 706B.

As previously noted, another challenge faced by users is that although component housing 112 can be mounted on the back of electronic device sleeve 110 (FIGS. 1 and 111), tools are used to engage the screw bosses on the electronic device sleeve. An example of the present disclosure facilitates toolless mounting of component housing 112 to electronic device sleeve 110 by providing locking members 706A, 706B having threaded posts that can be attached to electronic device sleeve 110 without a tool. Corresponding apertures 704A, 704B of component housing 112 secures component housing 112 to electronic device sleeve 110. In this manner, component housing 112 installation is highly efficient and convenient for many users.

Prior to mating, a user without a tool can attach first and second locking members 706A, 706B to a sleeve bracket 708, which may be attached to electronic device sleeve 110 of FIG. 11. Although not shown, sleeve bracket 708 is attached to bottom panel 1120E (FIG. 11) of electronic device sleeve 110.

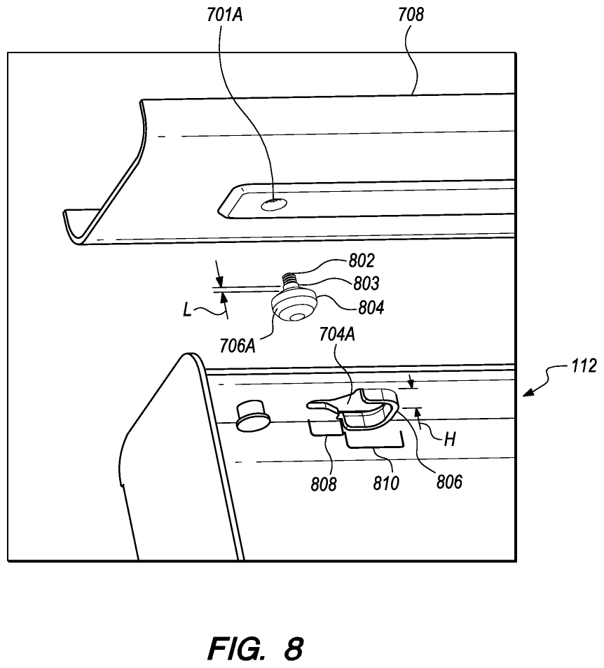

After first and second locking members 706A, 706B have been attached to sleeve bracket 708, first and second mating apertures 704A, 704B are respectively mated and locked with first and second locking members 706A, 706B. Specifically, once the locking members are attached to sleeve bracket 708, first and second mating apertures 704A, 704B are aligned with and inserted over first and second locking members 706A, 706B. First and second mating apertures 704A, 704B are then slid into the locking members to interlock the apertures and locking members as further described with reference to FIG. 8. Consequently, component housing 112, door 114 are securely attached to electronic device sleeve 110 as shown in FIGS. 1, 9 and 10.

FIG. 8 illustrates first locking member 706A of FIG. 7.

In FIG. 8, first locking member 706A can attach component housing 112 to sleeve bracket 708 (FIG. 7) of electronic device sleeve 110. This attachment is made with a threaded post 802 of first locking member 706A. In one example, threaded post 802 may be a cam peg. First locking member 706A may have a head 804 that is sized for grasping and manipulation by a user's hand. First locking member 706A may also include a body 803 as shown. The length “L” of body 802 may correspond to the height “H” of the raised lip 806.

In FIG. 8, first mating aperture 704A can mate with first locking member 706A as previously discussed with reference to FIG. 7. First mating aperture 704A includes an unlock area 810 and a lock area 808 having a raised lip 806 extending around the unlock area to provide a softer edge around unlock area 810.

Prior to mating, a user without a tool can attach first locking member 706A by grasping and rotating head 804 to insert threaded post 802 into a corresponding sleeve hole 701A. Since first locking member 706A can be fastened without a tool, the user need not search for a screwdriver or other like tools to complete attachment. Consequently, attachment of component housing 112 and electronic device sleeve 110 is faster and more convenient.

After threaded post 802 is attached, first mating aperture 704A and first locking member 706A are aligned. The alignment is such that head 804 of first locking member 706A is positioned over unlock area 810 of first mating aperture 704A. In this example, raised lip 806 extends around unlock area 810 to create a softer edge around unlock area 810. However, in another example, unlock area 810 may not have a raised lip. After alignment, unlock area 810 is inserted over head 804 of first locking member 706A. Thereafter, first mating aperture 704A is slid from unlock area 810 to lock area 808 to interlock component housing 112 and electronic device sleeve 110.

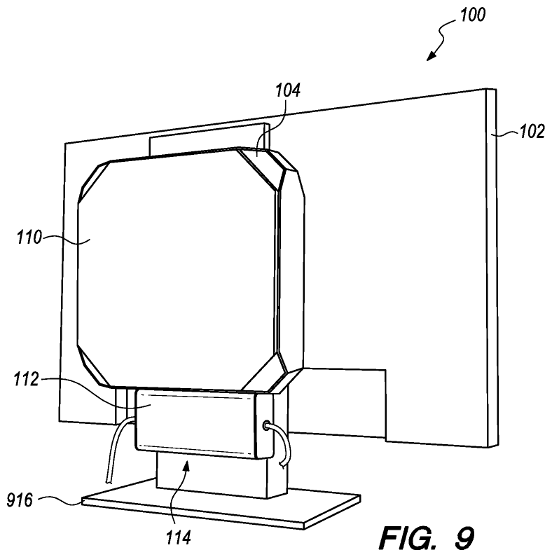

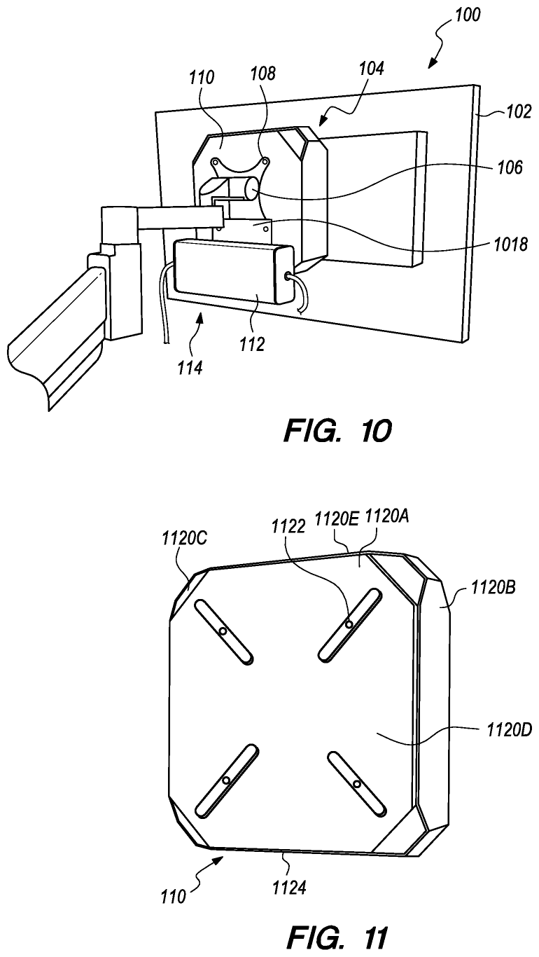

Referring now to FIG. 9, an example configuration to attach component housing 112/door 114 to a stand 916 is shown. Unlike the example of FIG. 1, component housing 112/door 114 is not secured to the side of monitor arm 106. Rather, component housing 112/door 114 is secured below electronic device sleeve 110. Other configurations may be applicable. For example, as shown in FIG. 10, component housing 112 is not secured to the side of monitor arm 106 as in FIG. 1. Rather, component housing 112 is secured below electronic device sleeve 110. This configuration uses an angled bracket 1018 to secure component housing 112 into place.

FIG. 11 illustrates an example electronic device sleeve 110 of FIG. 1, in which computing unit 104 is disposed.

In FIG. 11, electronic device sleeve 110 is formed into an enclosure by adjacent panels that are substantially orthogonally disposed to each other. As shown, the panels include front panel 1120A, right side panel 11206, left side panel 1120C, back panel 1120D and bottom panel 1120E. An opening 1124 is oppositely disposed from bottom panel 1120E.

As shown, electronic device sleeve 110 also includes plural mounting holes 1122 to receive fasteners to secure a processing unit within the sleeve or to secure the sleeve to a mounting surface. In one example, mounting holes 1122 are VESA (video electronics standards association). Common VESA standards such as “200×200” or “400×400” define the distance in millimeters between four mounting holes on a viewing device.

In use, computing device 104 is slid into opening 1124 until contact with bottom panel 1120E is made. Fasteners (not shown) inserted through mounting holes 1122 are then used to secure computing device 104 to electronic device sleeve 110. Thereafter, electronic device sleeve 110 with computing device 104 enclosed therein is secured to a mounting surface (such as monitor arm 106 of FIG. 1) via sleeve mounting holes 1122.

In this manner, examples of the present disclosure facilitate toolless mounting of component housing to electronic device sleeve. Examples of the present disclosure also facilitate the hinged coupling of doors to component housing. When opened, doors are not dislodged and remain connected to component housing. This system is highly beneficial and users need not track the doors. The doors can also be easily detached (or attached) as desired by users.

While the above is a complete description of examples of the disclosure, additional examples are also possible. Thus, the above description should not be taken as limiting the scope of the disclosure which is defined by the appended claims along with their full scope of equivalents.

I claim:

1. A system comprising:
a housing defining an interior to receive components of an electronic device;
a door hingedly attached to the housing;
a post coupled to the door, the post having an elongated body with a spherical ball at an end of the post;
a slot to receive the post, the slot shaped to correspond to a shape of the elongated body and the spherical ball; and
a socket connected to the slot, the socket to mate with the spherical ball and to cause rotation of the door about the socket to open or close the interior of the housing.

2. The system of claim 1 wherein an elongated section of the slot extends from a back area to a front area of the socket to permit axial rotation of the door.

3. The system of claim 1 further comprising a locking member having a threaded post to attach to an electronic device sleeve without a tool.

4. The system of claim 3 wherein the housing includes an aperture to mate with the locking member to secure the housing and the electronic device sleeve.

5. The system of claim 4 wherein the aperture includes a lock area and an unlock area having a raised lip extending around the unlock area.

6. The system of claim 1 wherein a width of the socket extends from a first side wall to a second side wall of the housing.

7. A system comprising:
an enclosure having an opening to receive components of an electronic device, wherein the enclosure is to attach to a sleeve in which the electronic device is disposed;
a lid for the enclosure;
a post hinge attached to lid, the post hinge having an elongated body with a spherical end;
a socket hinge attached to the enclosure, wherein a width of the socket hinge extends from a first side wall to a second side wall of the enclosure, wherein the socket hinge is to mate with the spherical end to cause hinged rotation of the lid about the socket hinge; and
a locking member having a threaded post to attach to the sleeve without a tool.

8. The system of claim 7 further comprising a slot to receive the post hinge, wherein the slot includes an elongated section and a spherical section to receive the post hinge.

9. The system of claim 8 wherein the spherical section of the slot is positioned above the socket hinge to cause downward movement of the post hinge to mate with the socket hinge.

10. The system of claim 8 wherein the spherical section of the slot is positioned at a rear of the enclosure to attach or detach the post hinge.

11. The system of claim 8 wherein the elongated section of the slot extends from a back area to a front area of the socket hinge to permit rotation of the lid.

11. The system of claim 7 wherein the enclosure includes an aperture to mate with the locking member to attach the enclosure and the sleeve.

12. The system of claim 11 wherein the aperture includes an unlock area having a raised lip, the unlock area sized to receive a head of the locking member.

13. A system comprising:
a joint assembly to couple a cover and a component case, wherein the component case is to hold components of an electronic device, wherein the joint assembly comprises:
a protrusion coupled to the cover, the protrusion having an extended support with a circular end;
a cavity; and
a slot located above the cavity, to receive the protrusion, wherein the cavity is to mate with the circular end and to cause rotation of the cover to open or close the component case.

14. The system of claim 13 wherein the slot includes an elongated section and a spherical section to receive the protrusion.

15. The system of claim 13 wherein the spherical section of the slot is positioned at a rear of the component case to attach or detach the protrusion.
